(19) United States
(12) Patent Application Publication
(10) Pub. No.: US 2025/0266054 A1
(43) Pub. Date: Aug. 21, 2025

(54) WRITER FOR HUMAN-READABLE EXTREMELY HIGH DENSITY PERMANENT DATA STORAGE

(71) Applicant: BRIGHAM YOUNG UNIVERSITY, Provo, UT (US)

(72) Inventors: Barry Mark Lunt, Provo, UT (US); Matthew R. Linford, Orem, UT (US); Shiuh-hua Wood Chiang, Vineyard, UT (US)

(73) Assignee: BRIGHAM YOUNG UNIVERSITY, Provo, UT (US)

(21) Appl. No.: 19/053,875

(22) Filed: Feb. 14, 2025

Related U.S. Application Data
(60) Provisional application No. 63/554,677, filed on Feb. 16, 2024.

(51) Int. Cl. G11B 5/008

(52) U.S. Cl. CPC G11B 5/00813; G11B 2220/90

(57) ABSTRACT

A writing device is provided which includes one or more emitters disposed over a tape. The writing device further includes a controller. The controller controls the emitters and instructs the emitters to write one or more pixels of information on the tape.

### PRIORITY CLAIM

This application claims the priority and benefit of U.S. Provisional Patent Application No. 63/554,677 filed on Feb. 16, 2024, which is incorporated by reference in its entirety.

### BACKGROUND

The story of humanity has been recorded in many forms since the earliest humans walked the planet Earth. Our current understanding of history tells us that early humans lacked meaningful ways to create formal records. Histories of people and places were taught by spoken word from one generation of people to the next. These histories are largely lost now for many reasons. Oral traditions relied on at least one member of a group memorizing the oral tradition, without error, and teaching it to another person in a later generation. Such traditions relied on the survival of particular people to be passed on from one generation to another. These traditions also required that a person transmit the oral tradition to another without error. And further, these traditions required that the oral tradition be shared with a subsequent generation. Any break in the generational chain led to a complete loss of the oral history of the group.

Over time, language developed such that thoughts and spoken words could be expressed in a written form. Sumerian cuneiform is currently the oldest known written language, which is a series of wedge shaped marks carved into clay tablets. Egyptian hieroglyphs were also an ancient form of written language, which was both carved into various media, such as stones and wood, but was also painted and written on stones, papyrus, and painted, carved, or cast into metal. History knows about these languages and writing systems because some examples of written cuneiform and hieroglyphs survived through time to today. Ancient peoples realized that written language was a far better way to record their stories and history than passing histories from one generation to the next orally. With the advent of written language, oral histories were, in some cases, transcribed into written histories that could endure longer than their human carriers would live.

For thousands of years, humans relied on written texts to write their histories though methods other than carving, casting, and painting were developed. For example, new writing surfaces were invented, such as parchment and paper which were far easier to store than stone tablets. Many of the histories written on stone tablets were transcribed into a new format on paper or parchment to continue the history of people. In other words, as the storage medium for written language transformed from clay and stone to parchment and paper, written language was easier to store for many civilizations. Libraries were created to care for and maintain these records to maintain all of the histories that could be maintained.

Paper and parchment, in ancient times, were expensive commodities. Frequently, only one version of a book or a history was created and maintained in a library or a personal collection. Further, and unfortunately, paper and parchment are far less durable than stone. Fires and floods through years upon years of history destroyed many libraries and many histories that were the only ones of their kind, resulting in histories that were lost forever. While many parchment and paper books and histories did survive, many have been edited, mis-translated, mis-transcribed, or incorrectly interpreted for various reasons, including negligence, intentional changes, incompetence, and in some cases malevolence during re-transcription due to aging of the parchment and paper books. Other books and histories were censored for their content, in many cases. In either case, information in these documents was lost.

With the invention of the printing press, books became much easier to print in quantity which increased the likelihood of survival for many books. And, until very recently, printed books were how humans stored their histories and stories. When the transistor was invented, digital storage became a reality. Digital storage solved many of the storage issues for information. Instead of needing great buildings to house paper and parchment, a single memory storage could maintain more information than ever was stored in those great buildings and made that information accessible to anyone who desired access to it. Digital storage on magnetic tapes and disks, optical storage discs, semiconductor storage, and solid state storage media require little physical space to store high volumes of information.

Digital storage was as transformative to information storage as paper and parchment were to clay tablets. Digital storage has made information of any kind simple to obtain through the Internet, which was not possible even 50 years ago. More written information is generated now than has ever been generated in the history of humanity. While digital storage has had a massive effect on humanity, digital storage is still limited. For example, information stored in digital storage devices, are encoded, and stored in a manner that is virtually incomprehensible to all but the most technologically savvy of human beings, if that information could be obtained by those human beings at all. The weakness of digital storage is that digital storage requires machines to pull the stored information and provide it to a human being in a human-readable format. A human being cannot simply read information contained on an optical disc or a magnetic disk without a machine that is programmed to transfer different elements of the optical disc or magnetic disk into a human-readable form. For this reason, more than the simple storage of digital information is necessary to maintain digital information. The machines programmed to read digital information must also be maintained to provide a meaningful storage of information that can last through time. Digital information within a device that cannot access power or is somehow damaged, may be unrecoverable.

For this reason, there is a need to write information in a physically small footprint or package while also maintaining the information in a human readable form. To solve this need, a new type of writing technique is needed to write information on a new storage device in a human-readable form.

It is therefore one object of this disclosure to provide writing device to write on storage media on a microscopic level and in a human readable format. It is further an object of this disclosure to provide a writing device to write on a storage device which contains storage media that is both human readable, readily replicated, and easily stored.

### SUMMARY OF THE DISCLOSURE

Disclosed herein a writing device for writing on a non-magnetic or optical tape. The writing device includes one or more emitters disposed over a tape. The writing device further includes a controller which controls the one or more emitters. The one or more emitters are configured to write one or more pixels of information on the tape.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a prior art atomic microscopy tip.

FIG. 2 illustrates a field-emissive emitter.

FIG. 3 illustrates a writing device incorporating a plurality of emitters.

FIG. 4 illustrates a storage device after being written on by the atomic microscopy tip.

FIG. 5 illustrates a controller for the writing device.

### DETAILED DESCRIPTION

In the following description of the disclosure, reference is made to the accompanying drawings, which form a part hereof, and which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

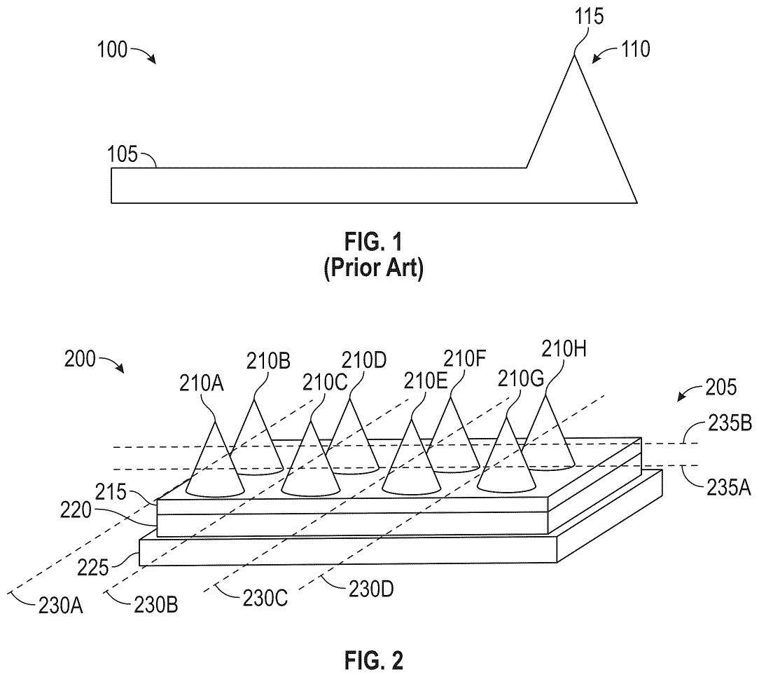

FIG. 1 illustrates a prior art atomic microscopy tip 100. Tip 100 is a conventional atomic force microscopy (“AFM”) or atomic tunneling microscope (“ATM” tip. Tip 100 is typically formed with a silicon, silicon nitride, or polycrystalline tungsten structure to form a cantilever 105, a pyramidal or conical tip 110 which ends at a vertex 115. Tip 100 is fashioned to produce a high intensity e-beam or another extremely high-resolution energy beam in an AFM microscope or in an ATM microscope to scan a sample on a microscopic level.

FIG. 2 illustrates a field-emissive emitter 200, arranged in an array 205 as a field emission display (“FED”) and having a plurality of individual microtips, 210A, 210B, 210C, 210D, 210E, 210F, 210G, and 210H. Microtips 210A-210H may further be fashioned of silicon, silicon nitride, tungsten polycrystalline structures, metals, metal alloys, or any other material known in the art. Microtips 210A-210H may be arranged on an electrically resistive layer 215 in an organized pattern, as will be discussed below. Electrically resistive layer 215 may be formed with any material that does not conduct electricity, which can include materials such as rubber, glass, plastics, crystal structures, or any other non-conductive material known in the art. Resistive layer 215 may be disposed on a cathode conductor layer 220 which may be an electrically conductive material for transferring electrical energy to or from microtips 210A-210H, depending on a type of scanning operation being performed at any particular time, using any of a scanning electron microscope (“SEM”), tunneling electron microscope (“TEM”), focused ion beam (“FIB”), positron emission tomography (“PET”), or an AFM/ATM device. Cathode conductor layer 225 may further be disposed on a glass layer 225, such that cathode layer 220 is insulated between resistive layer 215 and glass layer 225.

Array 205 is illustrated as having 8 microtips, microtips 210A-210H. However, neither this disclosure nor FIG. 2 is intended to limit the number of microtips used in array 205. While it is preferable that the number of microtips implemented in array 205 have an even number, it is not required for operation of array 205. As shown in FIG. 2, microtips 210A-210H are arranged in columns 230A-230D and rows 235A-235B. For example, column 230A includes microtip 210A and microtip 210B. Column 230B includes microtip 210C and microtip 210D. Column 230C includes microtip 210E and microtip 210F. Column 230D includes microtip 210G and microtip 210H. Similarly, and for example, row 235A may include microtip 210A, microtip 210C, microtip 210E, and microtip 210G. Row 235B, may include microtip 210B, microtip 210D, microtip 210F, and microtip 210H. Microtips 210A-210H may be so organized in any number to be associated with a particular row and column. In this manner, each one of the plurality of microtips 210A-210H may be individually excited to cause the one of the plurality of microtips 210A-210H to emit energy to write on a storage device.

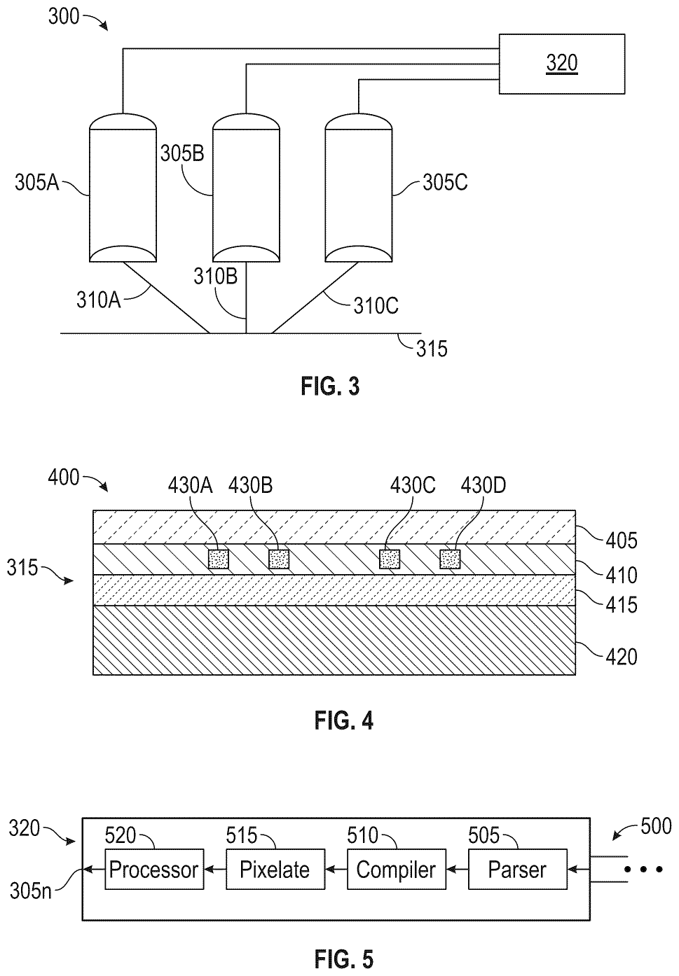

FIG. 3 illustrates a writing device 300. As shown in FIG. 3, writing device 300 is illustrated as using multiple emitters, emitter 305A, emitter 305B, and emitter 305C. Any number of emitters is possible, although FIG. 3 illustrates three emitters, emitter 305A, emitter 305B, and emitter 305C. It is also noted, however, that a single emitter, such as emitter 305A could be implemented in writing device 300, and incorporating field-emissive emitter 200, shown in FIG. 2. Each of emitters 305A-305C may emit an energy beam 310A-310C. A type of energy beam 310A-310C may depend on a type of emitter 305A-305C associated with a particular type of microscope device, such as SEM, TEM, FIB, PET, AFM, or ATM. Each emitter 305A-305C may be focused and configured to write on a storage device 315. Further, each emitter 305A-305C may be directed by controller 320 to write information in a certain part of storage device 315, as will be described below.

With respect to FIGS. 2 and 3, an e-beam, a high-resolution energy beam, or an AFM/AFM microtip, such as microtips 210A-210H, emitted by one or more of emitters 305A-305C may write on a recording layer 410 of a storage device 315. Storage device 315 may be implemented as a ½″ tape, which are commonly available in devices including a cassette, a VHS cassette, an 8-Track cassette, a reel to reel tape, or others. While these tapes are intended to be used for magnetic data storage, writing device 300 is non-magnetic and does not rely on the tapes in these devices being magnetic.

Writing device 300 may emit an energy beam from one or a plurality of beam emitters 305A-305C or cause energy to be emitted from field-emissive emitter 200. Each one of emitters 305A-305C, and each one of microtips 210A-210H may be individually controllable in terms of energy intensity (for emitters 305A-305C) or for penetration (for microtips 210A-210H) In this manner, each one of emitters 305A-305C or microtips 210A-210H may individually write at least part of one pixel on a recording layer 410 of a storage device. The pixels may be implemented in variable sizes in the storage device or may be uniform, facilitating halftone processes which have historically been used in printing black and white newspaper pictures. Beam emitters 305A-305C or field-emissive emitter 200 may be sized to be as wide as a tape in a storage device. For example, beam emitters 305-305C may write at a width of one half of an inch on a one half inch tape storage device. Likewise, field-emissive emitter 200 may incorporate microtips 210A-210H to have a width of one half of an inch to write on a one half inch tape storage device. The application of an energy beam 310A-310C directly or via field-emissive emitter 200 may form permanent alterations in the recording layer 410 of tape 400 in storage device 315. The permanent alterations in the recording layer 410 of tape 400 in storage device 315 may further be permanent alterations in physical or optical properties of the recording layer 410 of tape 400 in storage device 315.

Beam emitters 305A-305C and/or field-emissive emitter 200 may be manufactured by manufacturing processes frequently used with the manufacturing of semiconductors. In this manner, assuming a character size of 100 nm for a written character, an array of 125,000 emitters or microtips may write across a width of tape 400 in storage device 315 in 1 nm increments. The resolution of these characters is set in 1 nm increments (e.g., pixels), giving a pixel resolution of 1 nm in an X-Y plane of storage device 315. Tape 400 in storage device 315 may be advanced by 1 nm to write a next set of pixels across a width of tape 400 in storage device 315. A standard “linear tape open” (“LTO”) storage device includes approximately 960 meters of tape. At a character size of 100 nm, a single LTO storage device could store up to 6.583×10¹³ characters, which is approximately equivalent to the contents of the United States Library of Congress. At a write speed of 1 row of pixels each 10 microseconds (10 μs), a full row of 68.57 million characters could be written across tape 400 of storage device 315 every 100 milliseconds (100 ms). Writing an entire LTO storage device would take 27 hours. However, using an array of 125,000 emitters or tips to write across tape 400 of storage device 315, would increase the speed of writing by 125,000 times to approximately 0.7776 seconds.

Further, while each character having a size of 100 nm is too small for the human eye to see, microscopy techniques allow for the contents of tape 400 to be displayed through a lens or a screen associated with the microscopy device. In this manner, text may be written onto storage device 315 using plain language text (in any language) such that, when magnified, the written text may be read and understood by any person who is fluent in the written language.

FIG. 4 illustrates storage device 315 with information contained within storage device 315. Storage device 315 may be implemented as a magnetic, non-magnetic, or optical tape 400, having a plurality of layers. Tape 400 includes a lubricant layer 405 which may be optional, a recording layer 410, an optional adhesion promotion layer 415, and a mylar substrate layer 420. Lubricant layer 405 may be disposed on recording layer 115 to provide mechanical lubrication for a magnetic encoding/decoding device. While storage device 315 does not use a magnetic encoding/decoding device, LTO tapes, may be implemented with lubrication layer 405. However, in a preferable embodiment, a tape 400, specific to storage device 315 without a lubricant layer 405 may be used. Lubrication layer 405 may have a thickness of approximately 25 nanometers (25 nm) give or take a manufacturing tolerance of 5%. Lubricant layer 405 may be disposed on recording layer 410. Recording layer 410 may be non-magnetic and implemented using non-magnetic and highly ductile metals such as gold, silver, copper, other metals such as nickel, chrome, aluminum, and others known in the art, metal alloys or certain types of plastics and films. Recording layer 410 may have a thickness of approximately 50 nanometers (50 nm), give or take a manufacturing tolerance of 5%. recording layer 410 may be disposed on an adhesion promotion layer 415 or directly on plastic layer 420. Plastic layer 420 may be constructed from plastics including polyethylene terephthalate (“PET”-known as Mylar® in the relevant industries), poly-dimethyl siloxane, and other similar plastics known in the art. Adhesion promotion layer 415 may be optional and included in situations where recording layer 410 requires adhesive promotion to bond with PET layer 420 via adhesion promotion layer 415. PET layer 420 may have a thickness of approximately 5.2 micrometers to 8.9 micrometers (5.2 μm-8.9 μm) and serve as the structural substrate for tape 400 of storage device 315.

As shown in FIG. 4, a plurality of markings have been permanently altered by writing device 300 to encode four individual characters 430A, 430B, 430C, and 430D in tape 400. Each one of characters 430A-430D may have a total size as small as 100 nanometers (100 nm) and may comprise one hundred 1 nanometer (1 nm) pixels. Alternatively, each character could be written larger, up to 1 micrometer (1 μm) with 10 nanometer (10 nm) pixels. Character size may vary in a range between 100 nanometers (100 nm) and 1 millimeter (1 mm). Pixel size may vary in a range between 1 nanometer (1 nm) pixels and 1 micrometer (1 μm) pixels. Each pixel may be altered by one or more beam emitter, such as emitters 305A-305C, shown in FIG. 3 or by one or more microtip, such as microtip 210A-210H, shown in FIG. 2. Characters 430A-430D may be representative of characters, which include Latin characters, Chinese characters, Japanese characters, Korean characters, Cyrillic characters, Arabic characters, or any other characters which are part of a written human language, or any other characters intended to convey meaning.

Once characters 430A-430D are inscribed within recording layer 410, they may be read by humans using optical magnification. The use of optical magnification is considered to still be “human-readable” for the purposes of this disclosure. While advanced microscopes, such as a scanning electron microscope (“SEM”), a transmission electron microscope (“TEM”), or an electronic optical microscope may be easier to use for reading characters 430A-430D in recording layer 410, simple optical magnification may also be sufficient to read characters 430A-430D in recording layer 410, rendering characters 430A-430D “human-readable” without reliance on a particular machine which may not exist in the future. It is anticipated that storage device could be human-readable for 1000 years or more.

Simple optical magnification techniques render characters 430A-430D intelligible whether advanced microscope technology is available in the future or not. Further, while storage device 315 would maintain usefulness for an amount of time similar to an optical disc, the information inscribed in storage device 315 is stored in an analog human-readable fashion that does not require a specific machine.

FIG. 5 illustrates a controller 320 for writing device 300, shown in FIG. 3. Controller 320 may receive informational input 500 from another device. For example, a series of books may be provided as informational input 500 in a digital form. Property records may be provided as informational input 500 in a digital form. Any type of information may be extracted from an analog form into a digital form to be written into storage device 315, shown in FIG. 4. Once informational input 500 is received by controller 320, controller 320 may, by processor 520, perform various operations on informational input 500 to prepare the data for writing onto storage device 315. For example, a parser 505 may break large sections of informational input 505 data into smaller sections for the purpose of applying physical space parameters of storage device 315. Parser 505 may determine that writing data representative of a newspaper article on a one half inch tape, such as tape 400 shown in FIG. 4, is to arrange the writing in horizontally in a certain number of rows and a certain number of columns. As an example, a 1000 word newspaper article may be written as approximately 5000 characters with a size of 1 nm arranged in one row per word along a width (one half inch, for example) of tape 400. In this manner, parser 505 may determine how to arrange the written data on tape 400 for writing.

Once informational input 505 is parsed by parser 505, compiler 510 may determine which characters are to be printed on a particular portion of tape 400. For example, complier 510 may recognize each letter of each word in each row and generate instructions for which characters to write in a particular row of tape 400.

Once the characters for each word are identified by compiler 510, processor 520 may perform a pixelate operation 515. Pixelate operation may be performed in a manner to transform the characters compiled by compiler 510 into a plurality of pixels. For example, a character having a size of 100 nanometers may include one hundred one nanometer pixels from top to bottom. Some of those pixels may be written or not written depending on the character and how the character is located within the 100 nanometer space on tape 400 in a pseudo “dot-matrix” fashion. Pixels associated with each character in each word in each row may be identified by processor 520.

Once pixels have been determined, processor 520 may determine a number of available beam emitters 305A-305C or microtips 210A-210H to write each pixel on tape 400. Processor 520 may execute instructions which cause each one of beam emitters 305n (as shown in FIG. 5—though beam emitters 305n could also be considered as microtips 210A-210H depending on the type of beam used) to write an assigned pixel on tape 400. As each beam emitter 305n or microtip 210A-210H writes each pixel, a character is created on tape 400 which creates a word of the exemplary news article on each row of tape 400. A beam emitter 305 or microtip 210A-210H may write part of a pixel or a full pixel, depending on how a character is intended to be written on tape 400. For example, certain halftone processes may be used to create a black and white character or write a black and white picture out of a certain arrangement of pixels.

Other arrangements could be made, depending on how parser 505 parses informational input 500. For example, a series of newspaper articles may be best written horizontally along a length of tape 400. For example, every newspaper article written by a particular newspaper between 1900 and 2000 may be written on tape 400 and parser 500 may determine that the articles may be written on tape 400 horizontally across a length of a tape in a first row while every newspaper article from another newspaper written between 1900 and 2000 may be written across a length of a tape in a second row. In this example, compiler 510 may determine the characters needed in each row, which may be then pixelated by processor 510. Processor 520 may execute instructions to cause beam emitters 305n or microtips 210A-210H to write each pixel in each column (the width of each character—100 nm) across a length of tape 400 such that each column is written effectively simultaneously by beam emitters 305n or microtips 210A-210H. Once a first column of characters is written by beam emitters 305n or microtips 210A-210H, tape 400 may be advanced by 100 nanometers to a second column of characters to continue writing characters and words in each row.

These examples are only for the purpose of explanation and are not limiting to specific arrangements of characters or words or writing techniques. These examples are illustrative of various ways controller 320 may cause writing to be performed on tape 400.

Although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A writing device, the device comprising:
one or more emitters disposed over a tape;
a controller controlling the one or more emitters and configured to write one or more pixels of information on the tape.

2. The writing device of claim 1, wherein the one or more emitters emits an energy beam into the tape.

3. The writing device of claim 1, wherein the one or more emitters comprises one or more microtips.

4. The writing device of claim 3, wherein the microtips are disposed on a resistive layer.

5. The writing device of claim 4, wherein the resistive layer is disposed on a cathode conductor layer.

6. The writing device of claim 5, wherein the cathode conductor layer is disposed on a glass layer.

7. The writing device of claim 6, wherein the one or more microtips are arranged in rows and columns across one of the one or more emitters and wherein the controller controls each individual one of the one or more emitters.

8. The writing device of claim 1, wherein the controller includes a processor which performs parsing, compiling, and pixelating operations on informational input provided to the controller.

9. The writing device of claim 1, wherein the tape includes a recording layer.

10. The writing device of claim 9, wherein the recording layer is permanently altered by the writing device.

11. The writing device of claim 10, wherein the permanent alternation forms one or more pixels in the recording layer of the tape.

12. The writing device of claim 11, wherein the one or more pixels create one or more characters in the recording layer of the tape.

13. The writing device of claim 9, wherein the tape includes an adhesion promotion layer.

14. The writing device of claim 9, wherein the tape includes a lubricant layer.

15. The writing device of claim 9, wherein the tape includes a substrate layer.

16. The writing device of claim 15, wherein the substrate layer is a plastic layer.

17. The writing device of claim 1, wherein the one or more pixels have a resolution in the range of between 1 nanometer and 1 micrometer.

18. The writing device of claim 17, wherein the one or more pixels are arranged to make a character with a height of between 100 nanometers and 1 millimeter.

19. The writing device of claim 17, wherein the resolution of a character written by the writing device is in a range between 100 nanometers and 1 millimeter.

20. The writing device of claim 1, wherein the tape is disposed in a storage device and is a non-magnetic tape.
